(19) United States
(12) Patent Application Publication
(10) Pub. No.: US 2026/0277836 A1
(43) Pub. Date: Sep. 17, 2026

(54) METHOD, APPARATUS, DEVICE AND STORAGE MEDIUM FOR CONTROLLING MASTER-SLAVE DEVICE SWITCHING

(71) Applicant: Beijing Zitiao Network Technology Co., Ltd., Beijing (CN)

(72) Inventor: Jiajie ZHANG, Beijing (CN)

(21) Appl. No.: 19/376,786

(22) Filed: Oct. 31, 2025

(30) Foreign Application Priority Data
Mar. 14, 2025 (CN) 202510304586.9

(51) Int. Cl. G06F 13/36

(52) U.S. Cl. CPC G06F 13/36; G06F 2213/40

(57) ABSTRACT

A method, an apparatus, a device, and a storage medium for controlling master-slave device switching are provided. In response to a trigger of master-slave switching from the first device to a second device, respective event states of a plurality of functional modules in the first device are obtained. Each event state indicates whether a switching suppression event corresponding to a functional module is triggered. The first device is wirelessly connected to the second device, the first device is a master device, and the second device is a slave device. In response to the respective event states of the plurality of functional modules indicating that respective switching suppression events are not triggered, the first device is controlled to perform the master-slave switching from the first device to the second device. After the master-slave switching, the second device is switched to be a master device, and the first device is switched to be a slave device.

### CROSS-REFERENCE

The present application claims priority to Chinese Patent Application No. 202510304586.9, filed on Mar. 14, 2025 and entitled “METHOD, APPARATUS, DEVICE AND STORAGE MEDIUM FOR CONTROLLING MASTER-SLAVE DEVICE SWITCHING”, the entirety of which is incorporated herein by reference.

### FIELD

Example embodiments of the present disclosure generally relate to the field of computers, and in particular, to a method, an apparatus, a device, a computer-readable storage medium and a computer program product for controlling master-slave device switching.

### BACKGROUND

With the development of electronic information technology, wireless devices such as wireless headsets and wireless speakers are more and more widely used. Wireless devices not only get rid of the shackles of cables, but are also usually small in size, flexible and beautiful. In many cases, these wireless devices may need to be used in combination, such as two wireless headsets or multiple wireless speakers. These wireless devices used in combination are usually divided into a master device and a slave device, and corresponding functions are realized by interaction and cooperation between the master device and the slave device. Taking a true wireless (True Wireless Stereo, TWS) headset as an example, two TWS headsets are usually divided into a master headset and a slave headset. The master headset receives audio data from a terminal device and transmits it to the slave headset, which may realize synchronous playback of audio to maintain audio playback quality.

### SUMMARY

In a first aspect of the present disclosure, a method for controlling master-slave device switching is provided. The method includes: obtaining, in response to a trigger of master-slave switching from the first device to a second device, respective event states of a plurality of functional modules in the first device, wherein each event state indicates whether a switching suppression event corresponding to a functional module is triggered, wherein the first device is wirelessly connected to the second device, the first device is a master device, and the second device is a slave device; and controlling, in response to the respective event states of the plurality of functional modules indicating that respective switching suppression events are not triggered, the first device to perform the master-slave switching from the first device to the second device, wherein after the master-slave switching, the second device is switched to be a master device, and the first device is switched to be a slave device.

In a second aspect of the present disclosure, an apparatus for controlling master-slave device switching is provided. The apparatus includes: an obtaining module configured to obtain, in response to a trigger of master-slave switching from the first device to a second device, respective event states of a plurality of functional modules in the first device, wherein each event state indicates whether a switching suppression event corresponding to a functional module is triggered, wherein the first device is wirelessly connected to the second device, the first device is a master device, and the second device is a slave device; and a control module configured to control, in response to the respective event states of the plurality of functional modules indicating that respective switching suppression events are not triggered, the first device to perform the master-slave switching from the first device to the second device, wherein after the master-slave switching, the second device is switched to be a master device, and the first device is switched to be a slave device.

In a third aspect of the present disclosure, an electronic device is provided. The electronic device includes at least one processor and at least one memory. The at least one memory is coupled to the at least one processor and stores instructions executable by the at least one processor. The instructions, when executed by the at least one processor, cause the electronic device to perform the method of the first aspect.

In a fourth aspect of the present disclosure, a non-transitory computer-readable storage medium is provided. The non-transitory computer-readable storage medium stores computer-executable instructions, and the computer-executable instructions may be executed by a processor to implement the method of the first aspect.

In a fifth aspect of the present disclosure, a computer program product is provided, including computer-executable instructions, where the computer-executable instructions, when executed by a processor, implement the method of the first aspect.

It should be understood that the content described in this summary section is not intended to limit the key features or important features of the embodiments of the present disclosure, nor is it intended to limit the scope of the present disclosure. Other features of the present disclosure will become easy to understand through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference numbers refer to the same or similar elements, where:

FIG. 1A and FIG. 1B respectively illustrate schematic diagrams of example environments in which the embodiments according to the present disclosure may be implemented;

FIG. 2 illustrates a flowchart of a signaling flow for controlling master-slave device switching according to some embodiments of the present disclosure;

FIG. 3 illustrates a schematic diagram of an example of tag information according to some embodiments of the present disclosure;

FIG. 4 illustrates a flowchart of a process for controlling master-slave device switching according to some embodiments of the present disclosure;

FIG. 5 illustrates a schematic structural block diagram of an example apparatus for controlling master-slave device switching according to some embodiments of the present disclosure; and

FIG. 6 illustrates a block diagram of an electronic device that may implement multiple embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms and should not be interpreted as limited to the embodiments set forth herein. On the contrary, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, terms such as “include” and similar terms should be understood as open inclusion, that is, “include but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

In this article, unless otherwise specified, “in response to A” performing a step does not mean that the step is performed immediately after “A”, but may include one or more intermediate steps.

It should be understood that the data involved in the technical solution (including but not limited to the data itself, acquisition or use of the data) should follow the requirements of corresponding laws, regulations and related provisions.

It should be understood that before using the technical solutions disclosed in the embodiments of the present disclosure, the user should be informed of the type, range of use, use scenarios, etc. of personal information involved in the present disclosure and acquire the authorization of the user according to relevant laws and regulations in an appropriate manner.

For example, in response to receiving an active request from a user, prompt information is sent to the user to clearly prompt the user that the requested operation will require acquisition to and use of the user's personal information, so that the user may independently choose whether to provide the personal information to software or hardware, such as an electronic device, an application, a server or a storage medium, that performs the operations of the technical solution of the present disclosure based on the prompt information.

As an optional but non-restrictive implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It should be understood that the above process of notifying and acquiring user authorization is only illustrative and does not limit the implementations of the present disclosure. Other methods that satisfy the relevant laws and regulations may also be applied to the implementations of the present disclosure.

As mentioned above, in many cases, wireless devices may need to be used in combination, such as two wireless headsets, or multiple wireless speakers, etc. These wireless devices used in combination are usually divided into a master device and a slave device, and corresponding functions are realized through interaction and cooperation between the master device and the slave device. In use, switching may occur between the master device and the slave device. However, master-slave switching between the master device and the slave device in traditional technology may easily conflict with an operation that is currently performed by the master device or a current state of the master device. For example, two TWS headsets are usually divided into a master headset and a slave headset. In use, master-slave switching may occur between the master headset and the slave headset. If one module in the master headset is performing an operation while another module triggers master-slave switching, performing the master-slave switching from the master headset to the slave headset in this case may easily lead to abnormal operation of the former module or failure in performing the operation. Apparently, the control strategy for master-slave switching between the master device and the slave device in traditional technology needs to be improved.

In view of this, embodiments of the present disclosure propose an improved solution for controlling master-slave device switching. In this solution, it is assumed that a first device is wirelessly connected to a second device, the first device is a master device, and the second device is a slave device. Respective event states of a plurality of functional modules in the first device are obtained in response to a trigger of master-slave switching from the first device to the second device. Each event state indicates whether a switching suppression event corresponding to a functional module is triggered. The switching suppression event here refers to a specific operation performed by the corresponding functional module that may conflict with the master-slave switching, or a specific state of the corresponding functional module that may conflict with the master-slave switching. If it is determined that the respective event states of the plurality of functional modules all indicates that respective switching suppression events are not triggered, the first device is controlled to perform the master-slave switching from the first device to the second device, where after the master-slave switching, the second device is switched to be a master device, and the first device is switched to be a slave device.

In this embodiment of the present disclosure, if the master-slave switching from the first device to the second device is triggered, the event states of the functional modules in the first device (that is, the master device) will be considered comprehensively to determine whether any functional module triggers a switching suppression event. If none of the switching suppression events corresponding to the functional modules is triggered, it indicates that the master-slave switching operation is not prone to conflict with the current state of or the operation currently performed by each functional module, and therefore the active switching from the first device to the second device may be performed. In this way, conflict between the master-slave switching and the operation currently performed by or the state of the master device can be avoided, and the system stability of the device may be improved.

Various example implementations of the solution will be described in detail below in further combination with the drawings.

### Example Environment

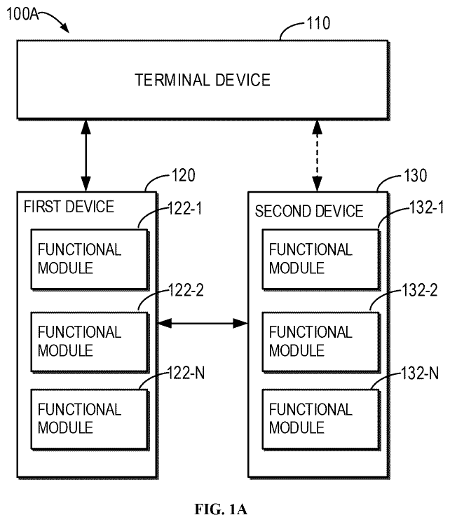

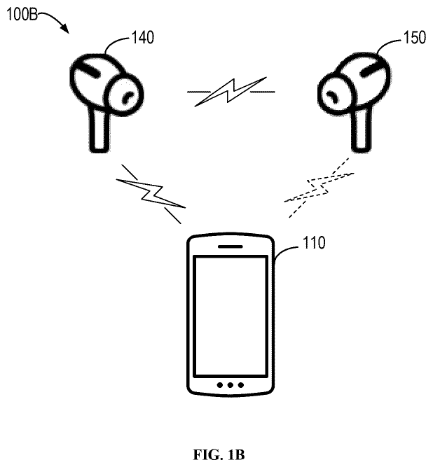

FIG. 1A illustrates a schematic diagram of an example environment 100A in which the embodiments of the present disclosure may be implemented. As shown in FIG. 1A, the environment 100A illustrates a terminal device 110, a first device 120 and a second device 130. At least one of the first device 120 and the second device 130 may be wirelessly connected to the terminal device 110, and the first device 120 and the second device 130 may also be wirelessly connected to each other, so that they may interact based on the wireless connection.

In some embodiments of the present disclosure, the first device 120 and the second device 130 may have master-slave roles. Specifically, a master-slave role of one of the first device 120 and the second device 130 may be a master device, and a master-slave role of the other of the first device 120 and the second device 130 may be a slave device. In some examples, the first device 120 may be a master device, and the second device 130 may be a slave device. In some other examples, the first device 120 may be a slave device, and the second device 130 may be a master device.

In some embodiments, a set of preset functions or a set of preset permissions of the master device may be in an enabled state, and a set of preset functions or a set of preset permissions of the slave device may be in a disabled state. In some examples, if the first device 120 is the master device and the second device 130 is the slave device, at least one of the first device 120 and the second device 130 may be wirelessly connected to the terminal device 110 (for example, based on Bluetooth or WIFI wireless connection, etc.), and the first device 120 and the second device 130 may also be wirelessly connected (for example, based on Bluetooth or WIFI wireless connection, etc.). The first device 120 may receive data (for example, audio data) from the terminal device 110, and the first device 120 may also transmit the received data to the second device 130. Certainly, the master device is not limited to having the permission to interact with the terminal device 110, and the master device may also enable a remote upgrade function, a function of communicating based on a private protocol, a voice assistant function, control permission over the slave device, etc. The embodiments of the present disclosure are not limited in this regard.

In some embodiments of the present disclosure, the first device 120 may be deployed with a plurality of functional modules 122, such as a functional module 122-1, a functional module 122-2, . . . , a functional module 122-N, etc., where N is a positive integer. The second device 130 may be deployed with a plurality of functional modules 132, such as a functional module 132-1, a functional module 132-2, . . . , a functional module 132-N, etc. In some embodiments, the plurality of functional modules 122 may include at least one of a remote upgrade module, a communication protocol module, a voice assistant module or an initial boot module, and the plurality of functional modules 132 may also include at least one of a remote upgrade module, a communication protocol module, a voice assistant module or an initial boot module.

In some embodiments, one or more predetermined functional modules of the plurality of functional modules of the master device may be in an enabled state, and one or more predetermined functional modules of the plurality of functional modules of the slave device may be in a disabled state. For example, if the first device 120 is the master device and the second device 130 is the slave device, the remote upgrade module, the communication protocol module, the voice assistant module and the initial boot module in the first device 120 may be in the enabled state, to enable the remote upgrade function, the permission to communicate based on the communication protocol module (for example, a private protocol module), the voice recognition function and the operation guidance function of the first device 120. The remote upgrade module, the communication protocol module, the voice assistant module and the initial boot module in the second device 130 may be in the disabled state, to disable the corresponding functions.

In some embodiments, master-slave switching between the first device 120 and the second device 130 may be performed to switch the master-slave roles. As an example, in the case where the first device 120 is the master device and the second device 130 is the slave device, the master-slave switching from the first device 120 to the second device 130 may be performed to switch the first device 120 to be a slave device and switch the second device 130 to be a master device. As another example, in the case where the first device 120 is the slave device and the second device 130 is the master device, the master-slave switching from the second device 130 to the first device 120 may be performed to switch the first device 120 to the master device and switch the second device 130 to the slave device.

In some embodiments, the terminal device 110 may relate to any type of mobile terminal, fixed terminal or portable terminal, including a mobile phone, a desktop computer, a laptop computer, a notebook computer, a netbook computer, a tablet computer, a media computer, a multimedia tablet, or any combination of the foregoing, including fittings and peripherals of these devices or any combination thereof.

In some embodiments of the present disclosure, the first device 120 and the second device 130 may include various devices that may interact with the terminal device 110 based on wireless connection. In some embodiments, the first device 120 and the second device 130 may include wireless audio playing devices. FIG. 1B illustrates a schematic diagram of another example environment 100B in which the embodiments of the present disclosure may be implemented. For the convenience of discussion, the environment 100B will be described with reference to the environment 100A of FIG. 1A.

In the environment 100B, the first device 120 may be implemented as a headset 140 (sometimes also referred to herein as a first wireless headset), and the second device 130 may be implemented as a headset 150 (sometimes also referred to herein as a second wireless headset). One of the headset 140 and the headset 150 may be configured as a master device, and the other of the headset 140 and the headset 150 may be configured as a slave device. The headset 140 and the headset 150 may be wirelessly connected to the terminal device 110, and the headset 140 and the headset 150 may also be wirelessly connected to each other.

In some embodiments, if the headset 140 is the master device and the headset 150 is the slave device, the headset 140 is wirelessly connected to the terminal device 110, and the headset 140 is wirelessly connected to the headset 150. The headset 140 may interact with the terminal device 110 based on the wireless connection. For example, the headset 140 may receive audio data from the terminal device 110 based on the wireless connection, and the headset 140 may also transmit audio data to the headset 150 based on the wireless connection, so as to realize synchronous playback of audio in the two headsets. In some other embodiments, if the headset 140 is the master device and the headset 150 is the slave device, the headset 140 and the headset 150 may both be wirelessly connected to the terminal device 110. Audio data transmission is performed between the headset 140 and the terminal device 110, and the headset 150 receives audio data from the headset 140. Certainly, the transmission between the headset 140 and the terminal device 110 and between the headset 140 and the headset 150 is not limited to audio signals, and for example, control signals, configuration information, software update files, etc. may also be transmitted.

It should be understood that the structures and functions of the elements in the environments 100A and 100B are described only for the purpose of illustration, without suggesting any limitation on the scope of the present disclosure. In other words, the structures, functions, numbers and connection relationships of the elements in the environments 100A and 100B may be changed according to actual needs. The present disclosure is not limited in this regard.

### Example Solution

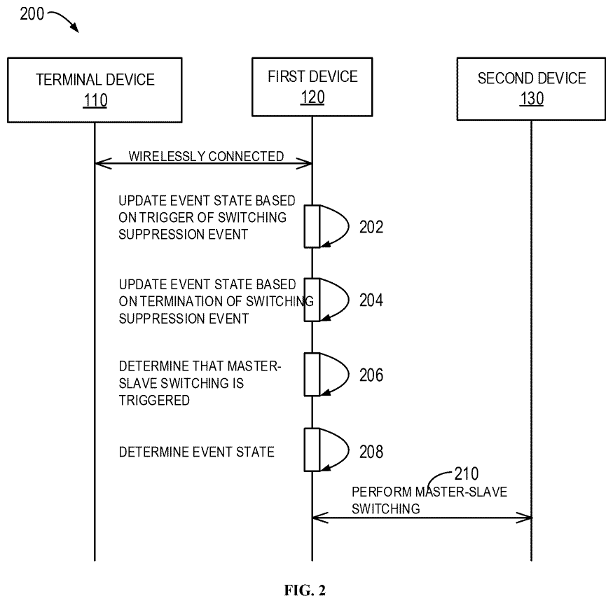

Some example embodiments of the present disclosure will be described below with continued reference to the drawings. FIG. 2 illustrates a flowchart of a signaling flow 200 for controlling master-slave device switching according to some embodiments of the present disclosure. The signaling flow 200 involves the terminal device 110, the first device 120 and the second device 130. Hereinafter, for the convenience of discussion, the signaling flow 200 will be described with reference to the environment 100A of FIG. 1A and the environment 100B of FIG. 1B, but this is only illustrative.

In some embodiments of the present disclosure, the plurality of functional modules 122 of the first device 120 have respective event states, and each event state indicates whether a switching suppression event corresponding to a functional module is triggered. The first device 120 may allow or restrict the master-slave switching from the first device 120 to the second device 130 based on whether the switching suppression event is triggered. Hereinafter, a scenario in which the switching suppression event is triggered and an event state is updated will be first introduced in combination with the signaling flow 200, and then a controlling process of the master-slave switching based on the event state will be introduced in combination with the signaling flow 200.

The signaling flow 200 illustrates an interaction process among the terminal device 110, the first device 120 and the second device 130 by using an example in which the first device 120 is a master device and the second device 130 is a slave device. At least one of the first device 120 and the second device 130 may be wirelessly connected to the terminal device 110 (for example, based on Bluetooth or WIFI wireless connection), and the first device 120 may also be wirelessly connected to the second device 130 (not shown in the figure). It should be understood that the above master-slave roles of the first device 120 and the second device 130 are only illustrative, and the first device 120 may also be a slave device and the second device 130 may be a master device. In this case, the operations performed by the first device 120 in the signaling flow 200 may also be implemented at the second device 130.

In some embodiments of the present disclosure, as shown in the signaling flow 200, the first device 120 may update (202) an event state corresponding to a first functional module of the plurality of functional modules 122 based on a trigger of a switching suppression event corresponding to the first functional module, so that the updated event state indicates that the switching suppression event corresponding to the first functional module is triggered.

The switching suppression event may include that the corresponding functional module 122 performs a specific operation or switches to a specific state, and conflict may occur between the specific operation performed by the functional module 122 or the specific state of the functional module 122 and the master-slave switching. For example, in the case where the functional module 122 performs the specific operation or is in the specific state, performing the master-slave switching from the first device 120 to the second device 130 may cause the specific operation to fail, cause the first device 120 to switch to another state, cause the master-slave switching to fail, etc.

In some embodiments, if it is determined that the functional module 122 is performing a specific operation that may conflict with the master-slave switching or the functional module 122 is in a specific state that may conflict with the master-slave switching, it is determined that the switching suppression event corresponding to the corresponding functional module 122 is triggered. In this case, the master-slave switching from the first device 120 to the second device 130 needs to be restricted. The first device 120 may update the event state corresponding to the functional module, so that the updated event state indicates that the corresponding switching suppression event is triggered, thereby avoiding conflict between the master-slave switching from the master device to the slave device and the specific operation currently performed by or the specific state of the corresponding functional module 122.

In some embodiments, the plurality of functional modules 122 may include at least one of a remote upgrade module, a communication protocol module, a voice assistant module or an initial boot module. The first functional module mentioned above may be any one of the plurality of functional modules 122. In this case, the switching suppression event corresponding to the first functional module may include a switching suppression event triggered by any one of the remote upgrade modules, the communication protocol module, the voice assistant module or the initial boot module. A scenario in which a switching suppression event is triggered will be introduced below in combination with some examples.

As an example, the first functional module may include the remote upgrade module. If the remote upgrade module performs a remote upgrade operation, it may be determined that a switching suppression event corresponding to the remote upgrade module is triggered. The first device 120 may update an event state corresponding to the remote upgrade module, so that the updated event state indicates that the switching suppression event of the remote upgrade module is triggered.

Alternatively or additionally, the first functional module may also include the communication protocol module. If the first device 120 uses the communication protocol module to establish a communication connection that conforms to a specific communication protocol (for example, a private protocol) with the terminal device 110 or another device. The communication connection may be interrupted by the master-slave switching, and the first device 120 determines that a switching suppression event corresponding to the communication protocol module is triggered, and updates an event state corresponding to the communication protocol module.

Alternatively or additionally, the first functional module may also include the voice assistant module. If the voice assistant module is awakened, it indicates that the voice assistant module is performing voice recognition. The master-slave switching may cause the voice recognition to fail, and it is determined that a switching suppression event corresponding to the voice assistant module is triggered, and the first device 120 updates an event state corresponding to the voice assistant module.

Alternatively or additionally, the first functional module may also include an initial boot module. If the initial boot module performs an initial boot operation, performing the master-slave switching may cause the initial boot operation to be interrupted, which in turn leads to failure in initial boot. At this time, the first device 120 determines that a switching suppression event corresponding to the initial boot module is triggered, and the first device 120 updates an event state corresponding to the initial boot module. Certainly, the above functional modules and the scenarios in which the functional modules trigger the corresponding switching suppression events are all illustrative, and any other appropriate functional modules may be selected according to actual needs, and the functional modules may also trigger the corresponding switching suppression events in any other appropriate scenarios. The embodiments of the present disclosure are not limited in this regard.

In practical applications, the event state of the functional module may be identified in various ways. In some embodiments, the event state may be indicated by tag information. If it is determined that the switching suppression event corresponding to the first functional module is triggered, the first device 120 may update the tag information to update the event state corresponding to the first functional module.

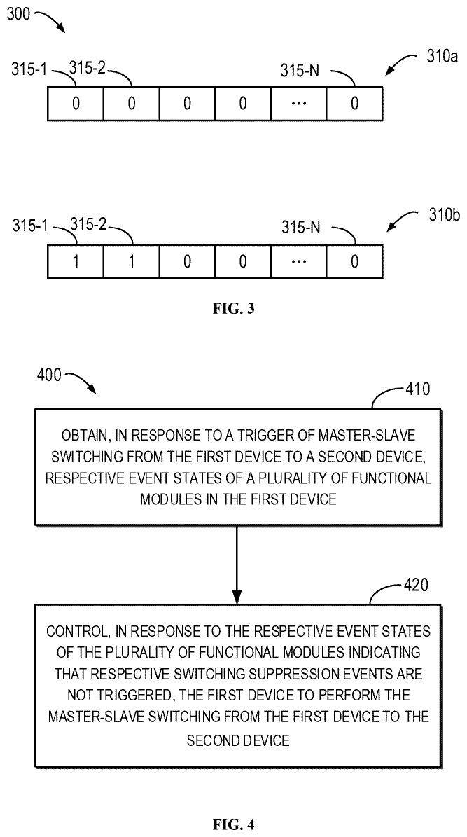

In some embodiments, the tag information may include tags respectively corresponding to the plurality of functional modules, and each tag indicates respective event state corresponding to a functional module. As an example, FIG. 3 illustrates a schematic diagram of an example 300 of tag information according to some embodiments of the present disclosure. As shown in FIG. 1A and FIG. 3, the tag information 310a may include a sequence composed of a plurality of tags 315, where the tag 315-1 may indicate an event state of the functional module 122-1, the tag 315-2 may indicate an event state of the functional module 122-2, the tag 315-N may indicate an event state of the functional module 122-N, and so on.

In some embodiments, each tag in the tag information may have a first state value or a second state value. The first state value may indicate that the switching suppression event of the corresponding functional module is triggered, and the second state value may indicate that the switching suppression event of the corresponding functional module is not triggered. As an example, as shown in FIG. 1B, if the headset 140 uses the communication protocol module to establish a wireless connection that conforms to a private protocol with the terminal device 110, it may be determined that the switching suppression event corresponding to the communication protocol module is triggered. The headset 140 may update the tag corresponding to the communication protocol module from the second state value to the first state value. As another example, still as shown in FIG. 1B, if the voice assistant module of the headset 140 is awakened, the headset 140 may update the tag corresponding to the voice assistant module from the second state value to the first state value.

In some examples, each tag in the tag information corresponds to one bit, where the first state value is one of 0 and 1, and the second state value is the other of 0 and 1. The number of bits of the tag information may be determined based on the number of functional modules related to the switching suppression event in the device. In this way, the information quantity of the tag information that needs to be maintained is small, which is beneficial to saving the storage space of the device. As an example, as shown in FIG. 3, the first state value may be 1, and the second state value may be 0. If the switching suppression event corresponding to the functional module 122-1 is triggered, the first device 120 may update the state value corresponding to the tag 315-1 from 0 to 1. If the switching suppression event corresponding to the functional module 122-2 is also triggered, the first device 120 may also update the state value corresponding to the tag 315-2 from 0 to 1 to acquire the updated tag information 310b. It should be understood that the above identification manner of the event state and the specific content of the tag information are both illustrative. In practical applications, any other appropriate manner may be selected to identify the event state according to actual needs, and the corresponding manner of updating the event state may also be different, which is not limited to the embodiments of the present disclosure.

In some embodiments of the present disclosure, as shown in the signaling flow 200, the first device 120 may update (204) an event state corresponding to a second functional module of the plurality of functional modules 122 based on the termination of a switching suppression event corresponding to the second functional module, so that the updated event state indicates that the switching suppression event corresponding to the second functional module is not triggered. In this way, in the case where the operation currently performed by or the state of the functional module 122 does not conflict with the master-slave switching, the event state is updated to avoid the influence of the event state on the normal master-slave switching function. In some embodiments, the second functional module may be the same as or different from the first functional module. In some examples, the second functional module may include any one of the remote upgrade modules, the communication protocol module, the voice assistant module and the initial boot module.

In some embodiments, the process of updating the event state based on the termination of the switching suppression event and the process of updating the event state based on the trigger of the switching suppression event may be reverse processes. In other words, if it is determined that the specific operation corresponding to the functional module 122 is completed, or the functional module 122 switches from the specific state to another state, the first device 120 determines that the switching suppression event of the corresponding functional module 122 is terminated, and updates the event state of the corresponding functional module 122, so that the updated event state indicates that the switching suppression event of the corresponding functional module 122 is terminated.

In some embodiments, if the first device 120 determines that the switching suppression event corresponding to the second functional module is terminated, the first device 120 may update a tag corresponding to the second functional module in the tag information, so that the updated tag indicates that the switching suppression event corresponding to the second functional module is not triggered. In some examples, if it is determined that the switching suppression event corresponding to the second functional module is terminated, the first device 120 may update the tag corresponding to the second functional module from the first state value to the second state value.

As an example, if it is determined that the voice assistant module of the headset 140 switches from an awakened state to a dormant state, it is determined that the switching suppression event corresponding to the voice assistant module is terminated, and the tag corresponding to the voice assistant module may be modified from 1 to 0. As another example, if it is determined that the remote upgrade operation performed by using the remote upgrade module has been completed, it is determined that the switching suppression event corresponding to the remote upgrade module is terminated. The headset 140 may modify the tag corresponding to the remote upgrade module from 1 to 0.

As yet another example, as shown in FIG. 3, if it is determined that the switching suppression event corresponding to the functional module 122-1 is terminated, the first device 120 may modify the state value of the tag 315-1 from 1 to 0. If it is determined that the switching suppression event corresponding to the functional module 122-2 is terminated, the first device may modify the state value of the tag 315-2 from 1 to 0 to update the tag information 310b to the tag information 310a.

It should be noted that, although FIG. 3 illustrates that the state values of two tags in the tag information 310a and the tag information 310b change, in practical applications, each update operation of the tag information may only update the state value of one of the tags. It should also be noted that the first state value may also be 0 or another value, and the second state value may also be 1 or another value, which is not specifically limited in the embodiments of the present disclosure.

In some embodiments of the present disclosure, as shown in the signaling flow 200, if the first device 120 determines (206) that the master-slave switching from the first device 120 to the second device 130 is triggered, the first device 120 determines (208) the respective event states of the plurality of functional modules 122. In a practical application scenario, the first device 120 may trigger the master-slave switching from the first device 120 to the second device 130 in response to the triggers of various events. The manner of triggering the master-slave switching from the first device 120 to the second device 130 will be introduced below in combination with some illustrative application scenarios. It should be understood that this is only illustrative, and the master-slave switching process may also be triggered in other ways.

In some embodiments, if it is determined that a difference between remaining power of the first device 120 and remaining power of the second device 130 exceeds a power threshold, the first device 120 triggers the master-slave switching from the first device 120 to the second device 130. As an example, the headset 140 may be a master device, and the headset 150 may be a slave device. One or more predetermined functional modules in the headset 140 may be in an enabled state, and one or more corresponding predetermined functional modules in the corresponding headset 150 may be in a disabled state. In this case, the power consumption of the headset 140 is higher than that of the headset 150. As the usage time increases, the difference between the remaining power of the two headsets 140 and 150 will become larger and larger. In order to adjust the power consumption speed of the two headsets 140 and 150, a power threshold may be set in advance. The headset 140 may interact with the headset 150 periodically or aperiodically based on the wireless connection to determine the remaining power of the headset 150. After that, the headset 140 may determine whether the difference between its remaining power and the remaining power of the headset 150 exceeds the power threshold. If the headset 140 determines that its remaining power is less than the remaining power of the headset 150, and determines that the difference between the remaining power of the two headsets 140 and 150 exceeds the power threshold, the headset 140 may trigger the master-slave switching from the headset 140 to the headset 150, and may determine the respective event states of the plurality of functional modules 122 of the headset 140.

In some embodiments, if it is determined that a difference between a first network capability of the first device 120 and a second network capability of the second device 130 exceeds an indicator threshold, the first device 120 triggers the master-slave switching from the first device 120 to the second device 130. The first network capability indicates a capability of transmitting data between the first device 120 and the terminal device 110 based on wireless connection, and the second network capability indicates a capability of transmitting data between the second device 130 and the terminal device 110 based on wireless connection. In this way, in the case where the communication quality between the first device 120 and the terminal device 110 is poor and the communication quality between the second device 130 and the terminal device 110 is good, the second device 130 may be switched to be a master device to be responsible for interacting with the terminal device 110, so that the quality of data transmission may be guaranteed.

In some examples, the first network capability and the second network capability may be indicated by one or more indicators such as signal strength, distance, signal-to-noise ratio, etc. For example, the headset 140 may determine the signal strength between the headset 140 and the terminal device 110, and may also determine the signal strength between the headset 150 and the terminal device 110. After that, the difference between the two groups of signal strength is determined. If the signal strength between the headset 140 and the terminal device 110 is weaker than the signal strength between the headset 150 and the terminal device 110, and the difference between the two groups of signal strength exceeds a preset signal strength threshold, the headset 140 triggers the master-slave switching from the headset 140 to the headset 150, thereby ensuring the transmission quality of audio data.

In some embodiments, if it is determined that the first network capability of the first device 120 meets a predetermined condition, the first device 120 triggers the master-slave switching from the first device 120 to the second device 130. The first device 120 may determine the respective event states of the plurality of functional modules. Here, the predetermined condition may indicate that the wireless communication quality between the first device 120 and the terminal device 110 is poor, for example, the predetermined condition may include that the first network capability is weaker than a network capability threshold. As an example, if the signal strength of the headset 140 is lower than a signal strength threshold, the headset 140 may trigger the master-slave switching from the headset 140 to the headset 150.

In some embodiments, if a master-slave switching instruction is received from the terminal device 110 wirelessly connected to the first device 120, the first device 120 triggers the master-slave switching from the first device 120 to the second device 130. In this way, the user can use the terminal device 110 to control the master-slave roles of the first device 120 and the second device 130 according to actual needs.

In some embodiments, the first device 120 may obtain tag information associated with the plurality of functional modules 122 in response to the trigger of the master-slave switching. It may be learned from the foregoing content that the tag information may include a plurality of tags corresponding to the plurality of functional modules 122, and each tag indicates whether the switching suppression event corresponding to the corresponding functional module 122 is triggered. The first device 120 may determine whether the respective switching suppression events corresponding to the plurality of functional modules 122 are triggered based on the tag information.

In some examples, the tag may be configured to have a first state value or a second state value. If it is determined that the tag is configured to have the first state value, the first device 120 determines that the switching suppression event of the corresponding functional module 122 is triggered. If it is determined that the tag is configured to have the second state value, the first device 120 determines that the switching suppression event of the corresponding functional module 122 is not triggered. As an example, the headset 140 may obtain tag information, and the tag information may include a plurality of tags corresponding to the remote upgrade module, the communication protocol module, the voice assistant module and the initial boot module. If it is determined that the tag corresponding to the remote upgrade module has the first state value, it indicates that the headset 140 is using the remote upgrade module to perform a remote upgrade operation, and the headset 140 determines that the switching suppression event corresponding to the remote upgrade module is triggered. If it is determined that the tag corresponding to the voice assistant module has the second state value, it indicates that the voice assistant module is in the dormant state, and the headset 140 determines that the switching suppression event corresponding to the voice assistant module is not triggered.

In some examples, the first state value is one of 0 and 1, and the second state value is the other of 0 and 1. The first device 120 may determine whether the state value corresponding to the tag is 0 or 1 to determine whether the switching suppression event of the corresponding functional module 122 is triggered. As an example, as shown in FIG. 3, the first tag value may be 1, and the second tag value may be 0. If it is determined that the state values of the tag 315-1 to the tag 315-N in the tag information 310a are all 0, the first device 120 determines that the switching suppression events corresponding to the plurality of functional modules 122 are not triggered. If it is determined that the state values of the tag 315-1 and the tag 315-2 in the tag information 310b are 1, the first device 120 determines that the switching suppression events corresponding to the functional module 122-1 and the functional module 122-2 are triggered.

It should be noted that the above process of determining whether the switching suppression event is triggered based on the event state is only illustrative. In the case where the event state is indicated in different manners, the process of determining whether the switching suppression event is triggered based on the event state may be different. The embodiments of the present disclosure are not limited in this regard.

In some embodiments of the present disclosure, as shown in the signaling flow 200, if it is determined that the respective event states of the plurality of functional modules 122 all indicate that respective switching suppression events are not triggered, the first device 120 is controlled (210) to perform the master-slave switching from the first device 120 to the second device 130, where the second device 130 is switched to be a master device and the first device 120 is switched to be a slave device after the master-slave switching.

In some embodiments, the master-slave switching from the first device 120 to the second device 130 may include but is not limited to that the first device 120 switches a group of predetermined functional modules to a disabled state, and the second device 130 switches a group of predetermined functional modules to an enabled state to enable a group of predetermined functions. As an example, if the headset 140 performs the master-slave switching from the headset 140 to the headset 150, the headset 140 may switch the remote upgrade module, the communication protocol module, the voice assistant module and the initial boot module that are deployed in the headset 140 to the disabled state, and the headset 150 may switch the remote upgrade module, the communication protocol module, the voice assistant module and the initial boot module that are deployed in the headset 150 to the enabled state. After that, the headset 150 is switched to the master device, and the headset 140 is switched to the slave device.

As another example, as shown in FIG. 3, the headset 140 as the master device may be configured to be wirelessly connected to the terminal device 110, and the headset 150 as the slave device may be configured not to be directly wirelessly connected to the terminal device 110. If it is determined that the state values of the plurality of tags 315 of the tag information 310a of the headset 140 are all 0, it is determined that the switching suppression events corresponding to the plurality of functional modules 122 are all not triggered. In this case, the master-slave switching from the headset 140 to the headset 150 performed by the headset 140 may also include that the headset 150 establishes wireless connection with the terminal device 110, and the headset 140 disconnects the wireless connection with the terminal device 110. It should be understood that the above master-slave switching process is only illustrative. In the case where the functions and permissions of the master device and the slave device are different, the operations performed by the master-slave switching may be different. The embodiments of the present disclosure are not limited in this regard.

In some embodiments, if it is determined that the event state corresponding to at least one of the plurality of functional modules 122 indicates that the corresponding switching suppression event is triggered, the first device 120 is restricted from performing the master-slave switching from the first device 120 to the second device 130. That is, if it is determined that the switching suppression event corresponding to any one or more of the plurality of functional modules 122 is triggered, the first device 120 is restricted from performing the master-slave switching from the first device 120 to the second device 130. In this way, conflict between the master-slave switching and the operations currently performed by the plurality of functional modules 122 of the first device 120 can be avoided. As an example, as shown in FIG. 3, since the tag 315-1 and the tag 315-2 in the tag information 310b respectively indicate that the switching suppression events corresponding to the functional module 122-1 and the functional module 122-2 are triggered, the headset 140 is prohibited from performing the master-slave switching from the headset 140 to the headset 150.

It should be noted that the signaling flow 200 is only used to explain the improved solution, and the sequence of operations in the signaling flow 200 does not represent the sequence in a practical application scenario. For example, the control process of the master-slave switching based on the event state (206-210) may occur before the switching suppression event is triggered (202), between the switching suppression event being triggered (202) and the switching suppression event being terminated (204), or after the switching suppression event is terminated (204). The embodiments of the present disclosure are not limited in this regard.

In this way, in the embodiments of the present disclosure, if the master-slave switching from the first device 120 to the second device 130 is triggered, the event states of the functional modules 122 in the first device 120 will be considered comprehensively to determine whether any functional module 122 triggers a switching suppression event. If none of the switching suppression events corresponding to the functional modules 122 is triggered, it indicates that the master-slave switching operation is not prone to conflict with the current state of or the operation currently performed by each functional module 122, and therefore the master-slave switching from the first device 120 to the second device 130 may be performed. In this way, conflict between the master-slave switching and the operation currently performed by or the state of the master device can be avoided, and the system stability of the device may be improved.

### Example Process, Apparatus and Device

FIG. 4 illustrates a flowchart of a process 400 for controlling master-slave device switching according to some embodiments of the present disclosure. The process 400 may be implemented in the first device 120. It should be understood that the first device 120 is similar to the second device 130, for example, a plurality of functional modules included in the headset 140 and the headset 150 are corresponding. The process 400 and the apparatus 500 described below may be implemented in any one or both of the first device 120 and the second device 130, for example, in the case where the second device 130 is switched to the master device, the process 400 and the apparatus 500 may also be implemented in the second device 130.

At block 410, the first device 120 obtains respective event states of a plurality of functional modules in the first device in response to a trigger of master-slave switching from the first device to a second device, where each event state indicates whether a switching suppression event corresponding to a functional module is triggered, where the first device is wirelessly connected to the second device, the first device is a master device, and the second device is a slave device.

At block 420, the first device 120 controls the first device to perform the master-slave switching from the first device to the second device in response to the respective event states of the plurality of functional modules all indicating that the respective switching suppression events are not triggered, where after the master-slave switching, the second device is switched to be a master device, and the first device is switched to be a slave device.

In some embodiments, the first device includes a first wireless headset, the second device includes a second wireless headset, and the first device and the second device are communicatively connected to a terminal device.

In some embodiments, the process 400 further includes: restricting, in response to an event state corresponding to at least one of the plurality of functional modules indicating that a corresponding switching suppression event is triggered, the execution of the master-slave switching from the first device to the second device.

In some embodiments, obtaining respective event states of a plurality of functional modules includes: obtaining, in response to the trigger of the master-slave switching, tag information associated with the plurality of functional modules, the tag information comprising tags respectively corresponding to the plurality of functional modules, each tag indicating an event state corresponding to a functional module.

In some embodiments, each tag in the tag information is configured with one of the following: a first state value indicating that a switching suppression event corresponding to the functional module is triggered, or a second state value indicating that a switching suppression event corresponding to the functional module is not triggered.

In some embodiments, the master-slave switching from the first device to the second device is triggered by at least one of the following: a difference between remaining power of the first device and remaining power of the second device exceeding a power threshold, a difference between a first network capability of the first device and a second network capability of the second device exceeding an indicator threshold, the first network capability indicating a capability of transmitting data between the first device and a terminal device based on the wireless connection, the second network capability indicating a capability of transmitting data between the second device and the terminal device based on the wireless connection, the first network capability of the first device meeting a predetermined condition, the first network capability indicating a capability of transmitting data between the first device and a terminal device based on the wireless connection, or a master-slave switching instruction being received from the terminal device wirelessly connected to the first device.

In some embodiments, the process 400 further includes: updating, in response to a trigger of a switching suppression event corresponding to a first functional module of the plurality of functional modules, an event state corresponding to the first functional module, the updated event state indicating that the switching suppression event corresponding to the first functional module is triggered.

In some embodiments, the process 400 further includes: updating, in response to a termination of a switching suppression event corresponding to a second functional module of the plurality of functional modules, an event state corresponding to the second functional module, the updated event state indicating that the switching suppression event corresponding to the second functional module is not triggered.

In some embodiments, the plurality of functional modules include at least one of a remote upgrade module, a communication protocol module, a voice assistant module, and an initial boot module.

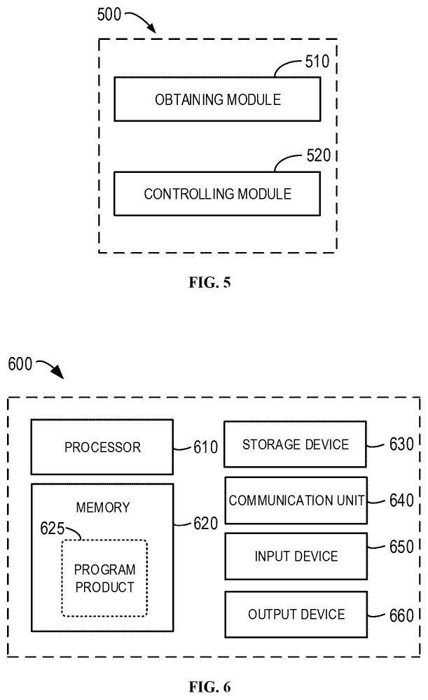

The embodiments of the present disclosure further provide a corresponding apparatus for implementing the above method or process. FIG. 5 illustrates a schematic structural block diagram of an example apparatus 500 for controlling master-slave device switching according to some embodiments of the present disclosure. The apparatus 500 may be implemented as or included in the first device 120. Each module/component in the apparatus 500 may be implemented by hardware, software, firmware, or any combination thereof.

As shown in FIG. 5, the apparatus 500 includes: an obtaining module 510 configured to obtain, in response to a trigger of master-slave switching from the first device to a second device, respective event states of a plurality of functional modules in the first device, wherein each event state indicates whether a switching suppression event corresponding to a functional module is triggered, wherein the first device is wirelessly connected to the second device, the first device is a master device, and the second device is a slave device; and a control module 520 configured to control, in response to the respective event states of the plurality of functional modules indicating that respective switching suppression events are not triggered, the first device to perform the master-slave switching from the first device to the second device, wherein after the master-slave switching, the second device is switched to be a master device, and the first device is switched to be a slave device.

In some embodiments, the first device includes a first wireless headset, the second device includes a second wireless headset, and the first device and the second device are communicatively connected to a terminal device.

In some embodiments, the apparatus 500 further includes: a restriction module configured to restrict, in response to an event state of at least one of the plurality of functional modules indicating that a corresponding switching suppression event is triggered, execution of the master-slave switching from the first device to the second device.

In some embodiments, the obtaining module 510 is further configured to: obtain, in response to the trigger of the master-slave switching, tag information associated with the plurality of functional modules, the tag information comprising tags respectively corresponding to the plurality of functional modules, each tag indicating an event state corresponding to a functional module.

In some embodiments, each tag in the tag information is configured with one of the following: a first state value indicating that a switching suppression event corresponding to the functional module is triggered, or a second state value indicating that a switching suppression event corresponding to the functional module is not triggered.

In some embodiments, the master-slave switching from the first device to the second device is triggered by at least one of the following: a difference between remaining power of the first device and remaining power of the second device exceeding a power threshold, a difference between a first network capability of the first device and a second network capability of the second device exceeding an indicator threshold, the first network capability indicating a capability of transmitting data between the first device and the terminal device based on the wireless connection, the second network capability indicating a capability of transmitting data between the second device and the terminal device based on the wireless connection, the first network capability of the first device meeting a predetermined condition, the first network capability indicating a capability of transmitting data between the first device and the terminal device based on the wireless connection, or a master-slave switching instruction being received from the terminal device wirelessly connected to the first device.

In some embodiments, the apparatus 500 further includes: a first update module configured to update, in response to a trigger of a switching suppression event corresponding to a first functional module of the plurality of functional modules, an event state corresponding to the first functional module, the updated event state indicating that the switching suppression event corresponding to the first functional module is triggered.

In some embodiments, the apparatus 500 further includes: a second update module configured to update, in response to a termination of a switching suppression event corresponding to a second functional module of the plurality of functional modules, an event state corresponding to the second functional module, the updated event state indicating that the switching suppression event corresponding to the second functional module is not triggered.

In some embodiments, the plurality of functional modules include at least one of a remote upgrade module, a communication protocol module, a voice assistant module, and an initial boot module.

The units and/or modules included in the apparatus 500 may be implemented in various ways, including software, hardware, firmware, or any combination thereof. In some embodiments, one or more units and/or modules may be implemented using software and/or firmware, such as machine executable instructions stored on a storage medium. In addition to machine executable instructions or as an alternative, some or all units and/or modules in the apparatus 500 may be implemented at least partially by one or more hardware logic components. As an example, rather than a limitation, example types of hardware logic components that may be used include field programmable gate arrays (FPGAs), application specific integrated circuits (ASICs), application specific standard parts (ASSPs), system on chips (SOCs), complex programmable logic devices (CPLDs), and more.

FIG. 6 illustrates a block diagram of an electronic device 600 in which one or more embodiments of the present disclosure may be implemented. It should be understood that the electronic device 600 shown in FIG. 6 is only illustrative, without suggesting any limitation on the functions and scopes of the embodiments described herein. The electronic device 600 shown in FIG. 6 may include or be implemented as the first device 120 in FIG. 1A or the apparatus 500 in FIG. 5.

As shown in FIG. 6, the electronic device 600 is in the form of a general electronic device. The components of the electronic device 600 may include but not limited to one or more processors 610, a memory 620, a storage device 630, one or more communication units 640, one or more input devices 650, and one or more output devices 660. The processor 610 may be a physical or virtual processor, and may perform various processing based on executable instructions stored in the memory 620. In a multi-processor system, multiple processors perform computer executable instructions in parallel to improve the parallel processing capability of the electronic device 600.

The electronic device 600 generally includes multiple computer storage medium. Such medium may be any available medium accessible to the electronic device 600, including but not limited to volatile and non-volatile medium, and removable and non-removable medium. The memory 620 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine readable medium, such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, a disk driver for reading from or writing into removable, non-volatile disks (such as a “floppy disk”), and an optical disk driver for reading from or writing into removable, non-volatile optical disks may be provided. In these cases, each driver may be connected to a bus (not shown) through one or more data medium interfaces. The memory 620 may include a computer program product 625, which has one or more executable instruction modules configured to perform various methods or actions of the various embodiments of the present disclosure.

The communication unit 640 implements communication with other electronic devices through the communication medium. In addition, the functions of the components of the electronic device 600 may be implemented by a single computing cluster or multiple computing machines, which may communicate through communication connections. Therefore, the electronic device 600 may use a logical connection with one or more other servers, network personal computers (PCs) or other network nodes to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) through the communication unit 640 as needed, the external devices such as a storage device, a display device, etc., communicate with one or more devices that enable a user to interact with the electronic device 600, or communicate with any devices (such as a network card, a modem, etc.) that enable the electronic device 600 to communicate with one or more other electronic devices. Such communication may be performed via input/output (I/O) interfaces (not shown).

According to an illustrative implementation of the present disclosure, a computer-readable storage medium is provided, having computer-executable instructions stored thereon, where the computer-executable instructions are executed by a processor to implement the method described above. According to an illustrative implementation of the present disclosure, there is further provided a computer-executable instruction product, the computer-executable instruction product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices and computer-executable instruction products implemented according to the present disclosure. It should be understood that each block of the flowcharts and/or block diagrams, and combinations of blocks in the flowcharts and/or block diagrams may be implemented by computer-readable executable instructions.

These computer-executable instructions may be provided to a processor of a general-purpose computer, a special-purpose computer, or other programmable data processing apparatus to produce a machine, so that these instructions, when executed by the processor of the computer or other programmable data processing apparatus, produce an apparatus for implementing a function/action specified in one or more blocks of the flowcharts and/or block diagrams. These computer-executable instructions may also be stored in a computer-readable storage medium, these instructions make the computer, the programmable data processing apparatus, and/or other devices work in a specific way, and thus the computer-readable medium storing the instructions includes a manufactured product, which includes instructions for implementing various aspects of the function/action specified in one or more blocks of the flowcharts and/or block diagrams.

The computer-executable instructions may be loaded onto a computer, another programmable data processing apparatus, or another device, so that a series of operation steps are performed on the computer, the other programmable data processing apparatus, or the other device to produce a computer-implemented process, so that the instructions executed on the computer, the other programmable data processing apparatus, or the other device implement the function/action specified in one or more blocks of the flowcharts and/or block diagrams.

The flowcharts and block diagrams in the drawings illustrate the possibly implemented architectures, functions and operations of the system, the method and the computer-executable instruction product according to multiple implementations of the present disclosure. In this regard, each block in the flowchart or block diagram may represent a module, an executable instruction or a part of an instruction, and the module, the executable instruction or the part of an instruction contains one or more executable instructions for implementing a specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combination of the blocks in the block diagrams and/or flowcharts may be implemented by a special-purpose hardware-based system that executes specified functions or actions, or may be implemented by a combination of special-purpose hardware and computer instructions.

The implementations of the present disclosure have been described above, and the above description is illustrative, not exhaustive, and is not limited to the disclosed implementations. Without departing from the scope and spirit of the illustrated implementations, many modifications and changes will be apparent to those of ordinary skill in the art. The terms used herein are chosen to best explain the principles, practical applications, or improvements to the technology in the market of the implementations, or to enable other ordinary skilled persons in the art to understand the implementations disclosed herein.

1. A method for controlling master-slave device switching, implemented at a first device, the method comprising:
obtaining, in response to a trigger of master-slave switching from the first device to a second device, respective event states of a plurality of functional modules in the first device, wherein each event state indicates whether a switching suppression event corresponding to a functional module is triggered, wherein the first device is wirelessly connected to the second device, the first device is a master device, and the second device is a slave device; and
controlling, in response to the respective event states of the plurality of functional modules indicating that respective switching suppression events are not triggered, the first device to perform the master-slave switching from the first device to the second device, wherein after the master-slave switching, the second device is switched to be a master device, and the first device is switched to be a slave device.

2. The method of claim 1, wherein the first device comprises a first wireless headset, the second device comprises a second wireless headset, and
wherein the first device and the second device are communicatively connected to a terminal device.

3. The method of claim 1, further comprising:
restricting, in response to an event state of at least one of the plurality of functional modules indicating that a corresponding switching suppression event is triggered, execution of the master-slave switching from the first device to the second device.

4. The method of claim 1, wherein obtaining respective event states of a plurality of functional modules comprises:
obtaining, in response to the trigger of the master-slave switching, tag information associated with the plurality of functional modules, the tag information comprising tags respectively corresponding to the plurality of functional modules, each tag indicating an event state corresponding to a functional module.

5. The method of claim 4, wherein each tag in the tag information is configured with one of the following:
a first state value indicating that a switching suppression event corresponding to the functional module is triggered, or
a second state value indicating that a switching suppression event corresponding to the functional module is not triggered.

6. The method of claim 1, wherein the master-slave switching from the first device to the second device is triggered by at least one of:
a difference between remaining power of the first device and remaining power of the second device exceeding a power threshold,
a difference between a first network capability of the first device and a second network capability of the second device exceeding an indicator threshold, the first network capability indicating a capability of transmitting data between the first device and a terminal device based on wireless connection, the second network capability indicating a capability of transmitting data between the second device and the terminal device based on wireless connection,
the first network capability of the first device meeting a predetermined condition, the first network capability indicating a capability of transmitting data between the first device and a terminal device based on wireless connection, or
a master-slave switching instruction being received from a terminal device wirelessly connected to the first device.

7. The method of claim 1, further comprising:
updating, in response to a trigger of a switching suppression event corresponding to a first functional module of the plurality of functional modules, an event state corresponding to the first functional module, the updated event state indicating that the switching suppression event corresponding to the first functional module is triggered.

8. The method of claim 1, further comprising:
updating, in response to a termination of a switching suppression event corresponding to a second functional module of the plurality of functional modules, an event state corresponding to the second functional module, the updated event state indicating that the switching suppression event corresponding to the second functional module is not triggered.

9. The method of claim 1, wherein the plurality of functional modules comprise at least one of a remote upgrade module, a communication protocol module, a voice assistant module, or an initial boot module.

10. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
obtaining, in response to a trigger of master-slave switching from the first device to a second device, respective event states of a plurality of functional modules in the first device, wherein each event state indicates whether a switching suppression event corresponding to a functional module is triggered, wherein the first device is wirelessly connected to the second device, the first device is a master device, and the second device is a slave device; and
controlling, in response to the respective event states of the plurality of functional modules indicating that respective switching suppression events are not triggered, the first device to perform the master-slave switching from the first device to the second device, wherein after the master-slave switching, the second device is switched to be a master device, and the first device is switched to be a slave device.

11. The electronic device of claim 10, wherein the first device comprises a first wireless headset, the second device comprises a second wireless headset, and
wherein the first device and the second device are communicatively connected to a terminal device.

12. The electronic device of claim 10, wherein the acts further comprise:
restricting, in response to an event state of at least one of the plurality of functional modules indicating that a corresponding switching suppression event is triggered, execution of the master-slave switching from the first device to the second device.

13. The electronic device of claim 10, wherein obtaining the event states corresponding to the plurality of functional modules respectively comprises:
obtaining, in response to the trigger of the master-slave switching, tag information associated with the plurality of functional modules, the tag information comprising tags respectively corresponding to the plurality of functional modules, each tag indicating an event state corresponding to a functional module.

14. The electronic device of claim 13, wherein each tag in the tag information is configured with one of the following:
a first state value indicating that a switching suppression event corresponding to the functional module is triggered, or
a second state value indicating that a switching suppression event corresponding to the functional module is not triggered.

15. The electronic device of claim 10, wherein the master-slave switching from the first device to the second device is triggered by at least one of:
a difference between remaining power of the first device and remaining power of the second device exceeding a power threshold,
a difference between a first network capability of the first device and a second network capability of the second device exceeding an indicator threshold, the first network capability indicating a capability of transmitting data between the first device and a terminal device based on wireless connection, the second network capability indicating a capability of transmitting data between the second device and the terminal device based on wireless connection,
the first network capability of the first device meeting a predetermined condition, the first network capability indicating a capability of transmitting data between the first device and a terminal device based on wireless connection, or
a master-slave switching instruction being received from a terminal device wirelessly connected to the first device.

16. The electronic device of claim 10, wherein the acts further comprise:
updating, in response to a trigger of a switching suppression event corresponding to a first functional module of the plurality of functional modules, an event state corresponding to the first functional module, the updated event state indicating that the switching suppression event corresponding to the first functional module is triggered.

17. The electronic device of claim 10, wherein the acts further comprise:
updating, in response to a termination of a switching suppression event corresponding to a second functional module of the plurality of functional modules, an event state corresponding to the second functional module, the updated event state indicating that the switching suppression event corresponding to the second functional module is not triggered.

18. The electronic device of claim 10, wherein the plurality of functional modules comprise at least one of a remote upgrade module, a communication protocol module, a voice assistant module, or an initial boot module.

19. A non-transitory computer-readable storage medium having computer-executable instructions stored thereon, the computer-executable instructions being executable by a processor to perform act comprising:
obtaining, in response to a trigger of master-slave switching from the first device to a second device, respective event states of a plurality of functional modules in the first device, wherein each event state indicates whether a switching suppression event corresponding to a functional module is triggered, wherein the first device is wirelessly connected to the second device, the first device is a master device, and the second device is a slave device; and
controlling, in response to the respective event states of the plurality of functional modules indicating that respective switching suppression events are not triggered, the first device to perform the master-slave switching from the first device to the second device, wherein after the master-slave switching, the second device is switched to be a master device, and the first device is switched to be a slave device.

20. The non-transitory computer-readable storage medium of claim 19, wherein the first device comprises a first wireless headset, the second device comprises a second wireless headset, and
wherein the first device and the second device are communicatively connected to a terminal device.
